(19) United States
(12) Patent Application Publication
(10) Pub. No.: US 2011/0187721 A1
(43) Pub. Date: Aug. 4, 2011

(54) LINE DRAWING PROCESSING APPARATUS, STORAGE MEDIUM STORING A COMPUTER-READABLE PROGRAM, AND LINE DRAWING PROCESSING METHOD

(76) Inventors: Itaru Furukawa, Kyoto (JP); Tsuyoshi Kubota, Kyoto (JP)

(21) Appl. No.: 12/520,963

(22) PCT Filed: Dec. 8, 2008
(86) PCT No.: PCT/JP2008/072272

§ 371 Date: Jun. 23, 2009

(30) Foreign Application Priority Data
Feb. 21, 2008 (JP) 2008-039992

(51) Int. Cl. G06T 11/20

(52) U.S. Cl. 345/443

(57) ABSTRACT

Multi-level gradation representation data D2 obtained by representing line drawing data D1 with a multi-level gradation is acquired, and cores are extracted from a line drawing. Further, a closed region surrounded by a core and smaller than a predetermined reference is selected. Then, the barycentric point of the selected closed region is determined, and a plurality of adjacent points adjacent to the barycentric point on the basis of a predetermined distance are defined. Thereafter, by reference to the multi-level gradation representation data D2, gradation values corresponding to the barycentric point and each of the adjacent points are acquired and compared with each other. Further, an adjacent point having the closest gradation value to the gradation value corresponding to the barycentric point is selected. Then, a boundary line lying between a closed region including the barycentric point and a closed region including the selected adjacent point is deleted.

### TECHNICAL FIELD

The present invention relates to a line drawing processing technique for combining a plurality of regions defined by drawing lines together.

### BACKGROUND ART

A typical example of uncolored line drawings includes manga. Manga is different from comics in English in that it is a (monochrome) line drawing having feels unique to Japan. Specifically, with manga, expression of gradation (a hue) and emotions of a character are expressed by various tones (screentone (a registered trademark of CELSYS, Inc.)), effect lines, black and white patterns such as solid (painting with a single color), lines, and the like. Manga is significantly different from comics using many color representations.

Traditionally, manga has been printed on paper and supplied onto the market. Because of too much color printing costs and the like, manga has been produced only in monochrome (uncoloredly) except for opening color pages of magazines and the like.

However, the number of sites on which digitized manga can be read through telecommunications lines is increasing rapidly because of the development of communications technology of terminal devices such as cellular phones and the like. Opportunities to be able to appreciate manga with liquid crystal monitors and the like are increasing, and there is a growing demand for colored manga. Outside Japan, because there is no tradition of monochrome manga, it is necessary to apply color to the monochrome manga for the purpose of globally spreading manga business. To this end, production operations for applying color to monochrome manga have been performed. A technique for automating the color application operation in a region included in a digital line drawing is disclosed, for example, in Patent Document 1.

Patent Document 1: Japanese Patent No. 2835752

### DISCLOSURE OF INVENTION

However, the technique disclosed in Patent Document 1 is a technique for applying color to animated cels drawn using trace lines on the premise of the application of color to animation. It is difficult to use the technique disclosed in Patent Document 1 directly for the automatic application of color to line drawings such as manga.

In manga, there are no trace lines on the premise of the application of color as in animation production, but a background and a subject are combined on a single sheet of line drawing. Thus, manga has a large number of tones and fine fill-in representations, and accordingly has a large number of small regions (minute regions). This presented a problem such that manual clipping and color painting require much labor.

In particular, when a large number of minute regions are produced in a region applied with tones such as shading, the operation for the application of color is very complicated.

As described above, there has been a strong demand for the efficiency of the operation of applying color to monochrome manga. However, the handling of the minute regions is very complicated.

The present invention has been made to solve the above-mentioned problem. It is therefore an object of the present invention to provide a technique for combining minute regions produced numerously with other regions rationally and efficiently.

To solve the above-mentioned problem, a line drawing processing apparatus according to a first aspect is a line drawing processing apparatus for combining closed regions separated by drawing lines together. The line drawing processing apparatus comprises: a line drawing data acquiring part for acquiring digitized line drawing data; a multi-level gradation representation part for spatially smoothing said line drawing data to thereby acquire multi-level gradation representation data having half-tone pixels; a region separation part for extracting said drawing lines from said line drawing data to separate regions surrounded by said drawing lines as a plurality of closed regions; and a region combination part for combining at least two closed regions included among said plurality of closed regions and adjacent to each other on the basis of a predetermined distance together in accordance with the degree of coincidence of gradation values of portions of said multi-level gradation representation data corresponding to the respective closed regions.

The line drawing processing apparatus according to the first aspect is capable of combining the at least two closed regions adjacent to each other on the basis of the predetermined distance together in accordance with the degree of coincidence with the gradation values of the multi-level gradation representation data to thereby rationally and automatically combine the plurality of closed regions together in units of regions similar in attribute to each other. This provides labor savings in the operation of cutting out a region, for example, during the application of color to the line drawing and the like.

A line drawing processing apparatus according to a second aspect is the line drawing processing apparatus according to the first aspect wherein said multi-level gradation representation part includes a reduction part for performing a reduction process on image data.

A line drawing processing apparatus according to a third aspect is the line drawing processing apparatus according to the first or second aspect wherein said multi-level gradation representation part includes an averaging part for performing an averaging process on the values of respective pixels with a multi-level gradation by using a filter of a predetermined size.

A line drawing processing apparatus according to a fourth aspect is the line drawing processing apparatus according to the first aspect wherein said multi-level gradation representation part includes a median filter processing part for acquiring the gradation values of pixels near an objective pixel to acquire a median value from said gradation values, thereby defining the median value as the gradation value of said objective pixel.

The line drawing processing apparatus according to the fourth aspect is capable of performing the median filter process on image data to be processed to eliminate noise included in the image data, thereby acquiring the multi-level gradation representation data reflecting the attributes of the original line drawing.

A line drawing processing apparatus according to a fifth aspect is the line drawing processing apparatus according to the first aspect wherein said region separation part extracts cores of said drawing lines from said line drawing data to separate regions surrounded by said cores as a plurality of closed regions.

A line drawing processing apparatus according to a sixth aspect is the line drawing processing apparatus according to the fifth aspect wherein said region combination part includes: a positional information acquisition part for selecting a first closed region smaller than a predetermined reference size from among said plurality of closed regions to acquire positional information about a first position included in the first closed region; a gradation value acquisition part for acquiring from said multi-level gradation representation data a first gradation value corresponding to said first position and a plurality of gradation values corresponding to at least two adjacent positions adjacent to said first position on the basis of a predetermined distance; and a position selection part for detecting a gradation value having the highest degree of coincidence with said first gradation value from among said plurality of gradation values to thereby select a second position having the detected gradation value, and wherein said region combination part deletes a boundary line lying between said first closed region including said first position and a second closed region including said second position to thereby combine said first closed region and said second closed region together in the form of a single closed region.

The line drawing processing apparatus according to the sixth aspect is capable of automatically combining a relatively small closed region and another closed region having a gradation value close to the gradation value corresponding to the small closed region. This reduces the number of relatively small closed regions.

A line drawing processing apparatus according to a seventh aspect is the line drawing processing apparatus according to the fifth aspect wherein said region combination part includes: an adjacent closed region detection part for selecting a third closed region smaller than a predetermined reference size from among said plurality of closed regions to detect one or more adjacent closed regions adjacent to said third closed region; an average gradation calculation part for calculating a third average gradation value, and one or more adjacent average gradation values, said third average gradation value being obtained by acquiring gradation values corresponding to pixels included in said third closed region from said multi-level gradation representation data and then averaging the gradation values, said one or more adjacent average gradation values being obtained by acquiring gradation values corresponding to pixels included in said one or more adjacent closed regions from said multi-level gradation representation data and then averaging the gradation values; and a closed region selection part for detecting one or more approximate adjacent average gradation values judged to have a high degree of coincidence with said third average gradation value on the basis of a predetermined criterion of judgment from among said one or more adjacent average gradation values to thereby select one or more approximate adjacent closed regions corresponding to said one or more approximate adjacent average gradation values from among said one or more adjacent closed regions.

A line drawing processing apparatus according to an eighth aspect is the line drawing processing apparatus according to the seventh aspect wherein said region combination part includes a comparison check part for making a comparison between said approximate adjacent average gradation values for approximate adjacent closed regions included among said one or more approximate adjacent closed regions and adjacent to each other, and wherein said region combination part combines said third closed region and said one or more approximate adjacent closed regions together in accordance with a result of the comparison check of said comparison check part.

A storage medium storing a computer-readable program according to a ninth aspect for solving the above-mentioned problem is a storage medium storing a computer-readable program executable by a computer, wherein execution of said program by said computer causes said computer to function as a line drawing processing apparatus comprising: a line drawing data acquiring part for acquiring digitized line drawing data; a multi-level gradation representation part for spatially smoothing said line drawing data to thereby acquire multi-level gradation representation data having half-tone pixels; a region separation part for extracting said drawing lines from said line drawing data to separate regions surrounded by said drawing lines as a plurality of closed regions; and a region combination part for combining at least two closed regions included among said plurality of closed regions and adjacent to each other on the basis of a predetermined distance together in accordance with the degree of coincidence of gradation values of portions of said multi-level gradation representation data corresponding to the respective closed regions.

The program according to the ninth aspect is capable of combining the at least two closed regions adjacent to each other on the basis of the predetermined distance together in accordance with the degree of coincidence with the gradation values of the multi-level gradation representation data to thereby rationally and automatically combine the plurality of closed regions together in units of regions similar in attribute to each other. This provides labor savings in the operation of cutting out a region, for example, during the application of color to the line drawing and the like.

A method of processing a line drawing according to a tenth aspect for solving the above-mentioned problem is a method of processing a line drawing, said method combining closed regions separated by drawing lines together. The method comprises the steps of: (a) acquiring digitized line drawing data; (b) spatially smoothing said line drawing data to thereby acquire multi-level gradation representation data having half-tone pixels; (c) extracting drawing lines from said line drawing data to separate regions surrounded by said drawing lines as a plurality of closed regions; and (d) combining at least two closed regions included among said plurality of closed regions and adjacent to each other on the basis of a predetermined distance together in accordance with the degree of coincidence of gradation values of portions of said multi-level gradation representation data corresponding to the respective closed regions.

The method of processing a line drawing according to the tenth aspect is capable of combining the at least two closed regions adjacent to each other on the basis of the predetermined distance together in accordance with the degree of coincidence with the gradation values of the multi-level gradation representation data to thereby rationally and automatically combine the plurality of closed regions together in units of regions similar in attribute to each other. This provides labor savings in the operation of cutting out a region, for example, during the application of color to the line drawing and the like.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is an external view of a line drawing processing apparatus according to a first embodiment of the present invention.

FIG. 2 is a diagram showing components of the line drawing processing apparatus.

FIG. 3 is a diagram showing a connection between functional blocks and a storage part in the line drawing processing apparatus.

FIG. 4 is a view showing an example of line drawing data read by a scanner.

FIG. 5 is a diagram showing a connection between functional blocks provided in a multi-level gradation representation part and the storage part.

FIG. 6 is a view showing an example of multi-level gradation representation data obtained by representing the line drawing data shown in FIG. 4 with a multi-level gradation.

FIG. 7 is a view showing an example of thinned data obtained by performing a thinning process on the line drawing data shown in FIG. 4.

FIG. 8 is a diagram showing an example of a data structure of region separation data.

FIG. 9 is a diagram showing functional blocks provided in a region combination part.

FIG. 10 is an illustration of a process performed by the region combination part.

FIG. 11 is an illustration of a process performed by the region combination part.

FIG. 12 is a view showing an example of region combination data acquired from the thinned data shown in FIG. 7.

FIG. 13 is a flow diagram for illustrating a procedure for operation of the line drawing processing apparatus.

FIG. 14 is a flow diagram for illustrating a procedure for operation of the multi-level gradation representation part.

FIG. 15 is a flow diagram for illustrating a procedure for operation of the region combination part.

FIG. 16 is an illustration of a process performed by the region combination part according to a second embodiment of the present invention.

FIG. 17 is a diagram showing functional blocks provided in the region combination part according to a third embodiment.

FIG. 18 is an illustration of an example of a combination process performed by the region combination part.

FIG. 19 is a diagram showing functional blocks provided in the region combination part according to a fourth embodiment.

FIG. 20 is a diagram showing functional blocks provided in the region combination part according to a fifth embodiment.

FIG. 21 is a view showing an example of a portion of the thin line data.

### BEST MODE FOR CARRYING OUT THE INVENTION

Preferred embodiments according to the present invention is described in detail with reference to the accompanying drawings.

### 1. First Embodiment

<1.1. Configuration and Function of Line Drawing Processing Apparatus>

<General Configuration>

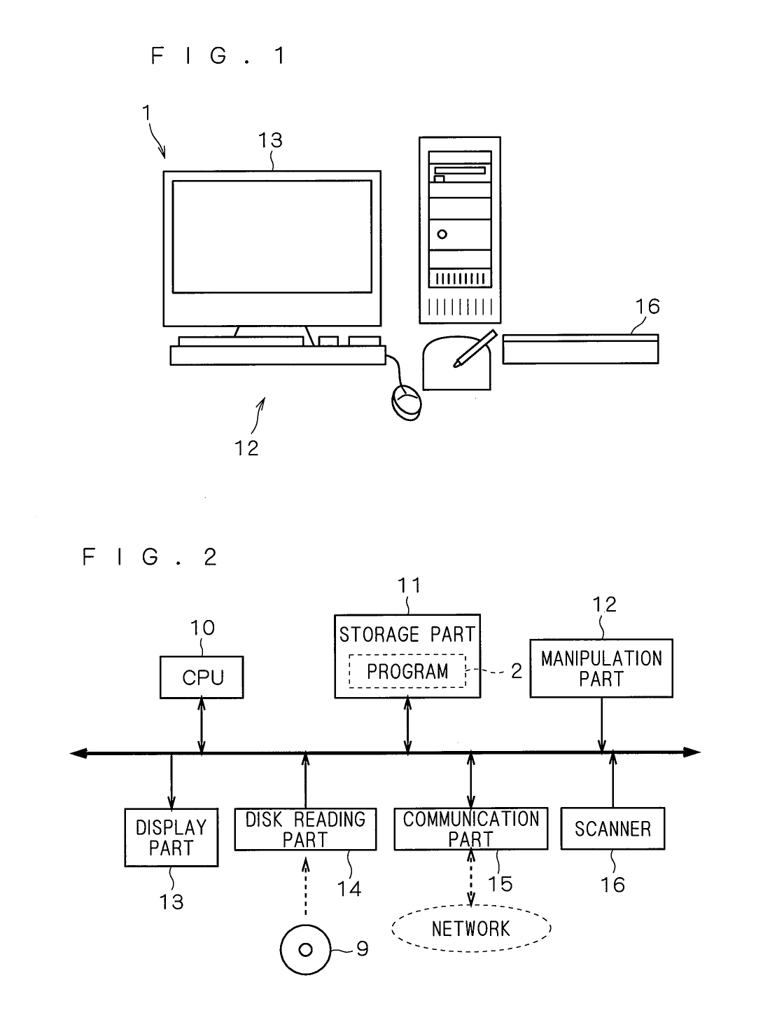

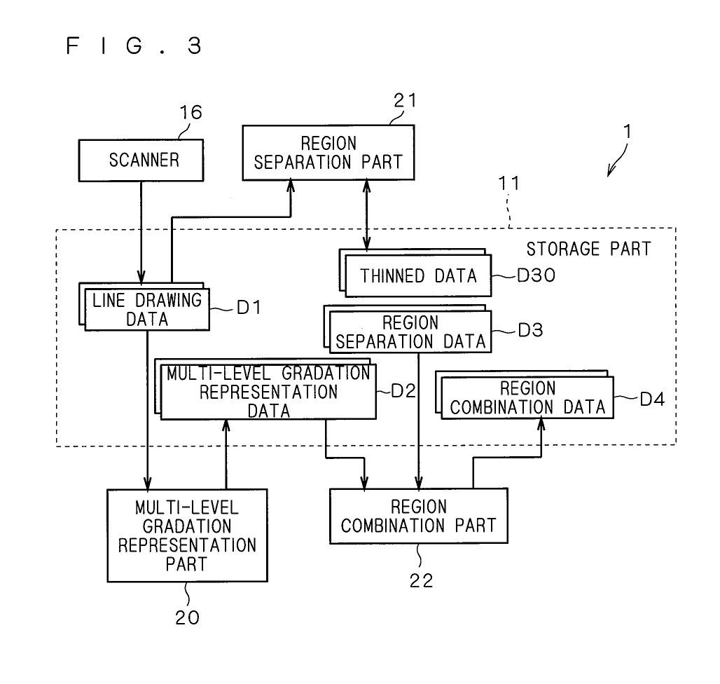

FIG. 1 is an external view of a line drawing processing apparatus 1 according to a first embodiment of the present invention. FIG. 2 is a diagram showing components of the line drawing processing apparatus 1. The line drawing processing apparatus 1 principally includes a CPU 10, a storage part 11, a manipulation part 12, a display part 13, a disk reading part 14, a communication part 15, and a scanner 16. The line drawing processing apparatus 1 has a function as a typical computer.

The CPU 10 operates in accordance with a program 2 stored in the storage part 11 to carry out the computations of various data and the generation of control signals, thereby controlling the components of the line drawing processing apparatus 1. Functional blocks implemented by the CPU 10 will be described later.

The storage part 11 includes a RAM and a hard disk that serve as temporary working areas of the CPU 10, and a ROM that is read only (not shown). The storage part 11 has a function as a recording medium for storing the program 2 and various data. The program 2 may be transferred from a recording medium 9 to be described later through the disk reading part 14 to the storage part 11. Alternatively, the program 2 may be transferred through the communication part 15 to the storage part 11.

The manipulation part 12 is used to input instructions of an operator to the line drawing processing apparatus 1. In other words, the manipulation part 12 functions as an input device in the line drawing processing apparatus 1. Specifically, the manipulation part 12 corresponds to, for example, a keyboard, a mouse, a graphics tablet (pen tablet: a registered trademark of Pentel Co., Ltd.), various buttons, and the like.

The display part 13 displays various data as an image onto a screen. In other words, the display part 13 functions as a display device in the line drawing processing apparatus 1. Specifically, the display part 13 corresponds to, for example, a CRT monitor, a liquid crystal display, and the like. However, the display part 13 may be a part having some of the functions of the manipulation part 12, such as a touch panel display.

The disk reading part 14 is a device for reading data stored in the recording medium 9 that is portable to transfer the data to the storage part 11. In other words, the disk reading part 14 functions as a data input device in the line drawing processing apparatus 1.

The line drawing processing apparatus 1 according to this embodiment includes a CD-ROM drive as the disk reading part 14. However, the disk reading part 14 is not limited to this, but may be, for example, a FD drive, a DVD drive, an MO device, and the like. In addition, when the disk reading part 14 has the function of recording data on the recording medium 9, the disk reading part 14 may act for some of the functions of the storage part 11.

The communication part 15 has a function for communicating through a network between the line drawing processing apparatus 1 and other apparatus groups which are not illustrated.

The scanner 16 is a reading device for reading uncolored line drawings. The scanner 16 includes a large number of image sensors, and has a function for acquiring a line drawing in the form of digital data.

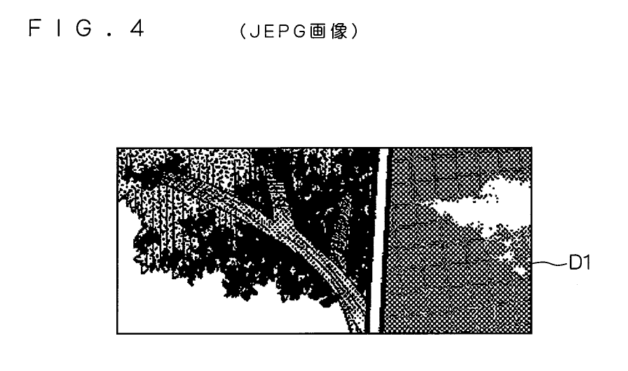

FIG. 3 is a diagram showing a connection between functional blocks and the storage part 11 in the line drawing processing apparatus 1. A multi-level gradation representation part 20, a region separation part 21, and a region combination part 22 shown in FIG. 3 are the functional blocks implemented principally by the CPU 10 operating in accordance with the program 2.

<Line Drawing>

FIG. 4 is a view showing an example of line drawing data D1 read by the scanner 16. A line drawing (a portion of manga) printed on such a printing base material (paper and the like) is read by the scanner 16, and the acquired line drawing data D1 is stored in the storage part 11.

The line drawings to be subjected to the processing of the line drawing processing apparatus 1 include analog images (originals) drawn on paper in some cases, and images that have been digitized in the past for publication in other cases. In either case, the line drawings are binary black and white images (monochrome images).

An analog image may be read as a binary image when the analog image is digitized by photoelectric reading using the scanner 16 and the like. In this case, however, the analog image is converted into a monochrome multi-level gradation (for example, 4 bits=16 levels of gradation, and 8 bits=256 levels of gradation) image representation before a multi-level gradation representation process to be described below.

Also, the image reading with a monochrome multi-level gradation may be done from the beginning. The “multi-level gradation” in the stage previous to the multi-level gradation representation process is such that each pixel is represented by a plurality of bits, and only two levels, i.e. white and black, are used as a matter of fact.

As shown in FIG. 4, various tones (patterns) are applied as monochrome patterns or designs to a typical uncolored line drawing, and the hues and the like of a background (for example, “sky” on the right side in FIG. 4) and an object (for example, “leaves of a tree” and “branches of a tree” on the left side in FIG. 4) are represented by the application of the tones. The term “line drawing” used herein includes an image including tones, solids and the like in addition to drawing lines.

<Multi-Level Gradation Representation Part 20>

The multi-level gradation representation part 20 has the function of spatially smoothing the monochrome line drawing data D1 as shown in FIG. 4 to thereby acquire multi-level gradation representation data D2 having half-tone pixels. In this embodiment, the multi-level gradation representation part 20 performs the multi-level gradation representation process including a reduction process, an averaging process, and a median filter process which is described below.

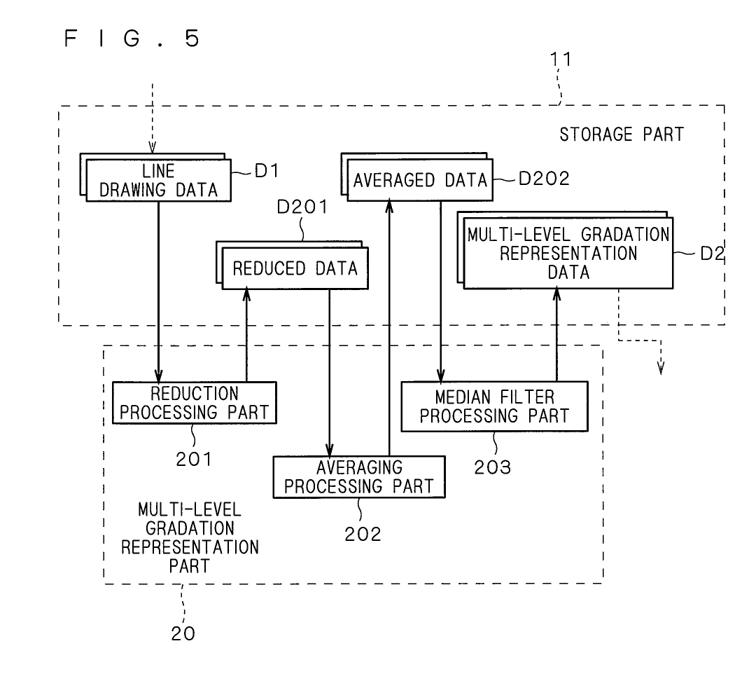

FIG. 5 is a diagram showing a connection between functional blocks provided in the multi-level gradation representation part 20 and the storage part 11. The multi-level gradation representation part 20 includes a reduction processing part 201, an averaging processing part 202, and a median filter processing part 203. These functional blocks perform processes to be described below.

<Reduction Processing Part 201>

The reduction processing part 201 performs the reduction process on the line drawing data D1 (image data) to acquire reduced data D201. The term “reduction process” used herein refers to the process of reducing a pixel block region having a predetermined size (N by N pixels) to one pixel. The reduction process is to calculate the mean value of all pixel values with their respective pixel densities represented by a plurality of bits for all pixels included in the pixel block region, and to define the pixel value of one pixel corresponding to the pixel block region as the mean value after the reduction.

The tones included in the line drawing is averaged and converted into a half-tone gradation by the reduction process of the line drawing data D1. A reduction ratio N is freely definable by an operator, but may be calculated, for example, by the following expression:

N=1/{2.0×(Image Resolution)/(Number of Lines of Tone)}

The number of lines of tone is defined as the number of lines per unit interval (for example, centimeter or inch) in accordance with the tone (screentone (a registered trademark of CELSYS, Inc.)) most commonly used in the uncolored line drawing being processed. The method of calculating the reduction ratio N, however, is not limited to this. Also, in this embodiment, this reduction process shall include the process of returning to a pixel size equal to that of the original line drawing data D1 (an enlargement process). This process may be executed, for example, after the averaging process or after the median filter process to be described below.

<Averaging Processing Part 202>

The averaging processing part 202 has the function of performing the averaging process with a multi-level gradation on the values of the respective pixels of the reduced data D201 acquired by the reduction processing part 201 described above by using a filter of a predetermined size. The term “averaging process” used herein refers to the process of obtaining the mean value of the pixels included in the predetermined size by the use of the filter (averaging filer) of the predetermined size. By performing this averaging process over the entire image data, the tones included in the original line drawing are further averaged and represented with a multi-level gradation.

The size (M by M pixels) of the averaging filter may be calculated, for example, by the following expression:

M=2.0×(Image Resolution)/(Number of Lines of Tone)

The method of calculating the size of the averaging filter, however, is not limited to this, but an operator may change the design thereof, as appropriate.

The line drawing processing apparatus 1 is capable of converting the monochrome tones included in the line drawing data D1 into half-tone gradation values by combining the reduction process of the reduction processing part 201 and the averaging process of the averaging processing part 202 described above.

<Median Filter Processing Part 203>

There is apprehension that image roughness (what is called “noise”) is included in averaged data D202 (image data) obtained by performing the reduction process and the averaging process described above. Such noise can be removed by the median filter process of the median filter processing part 203.

The term “median filter process” used herein refers to the process of acquiring a plurality of gradation values of the pixels in a region near an objective pixel, arranging the plurality of gradation values in ascending order, acquiring the median value thereof, and defining the median value as the gradation value of the objective pixel.

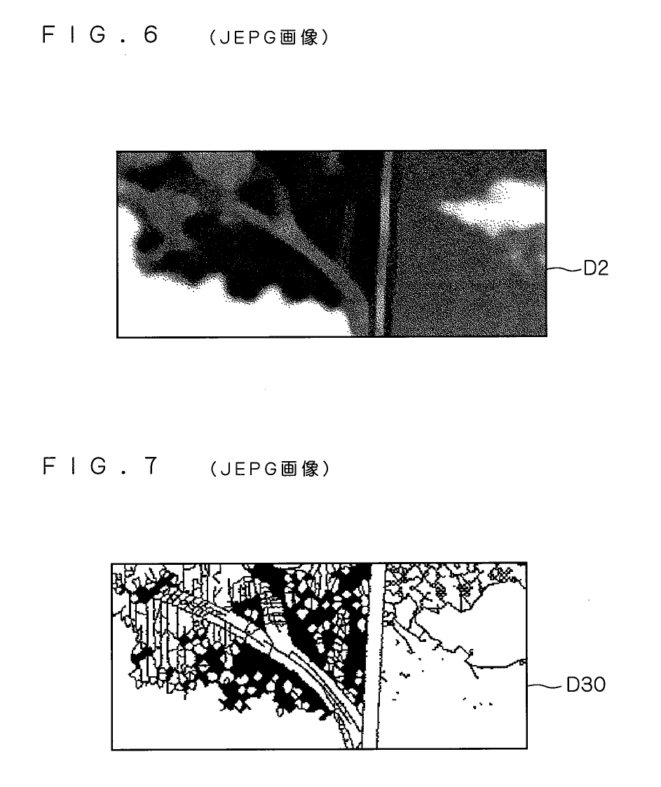

FIG. 6 is a view showing an example of the multi-level gradation representation data D2 obtained by representing the line drawing data D1 shown in FIG. 4 with a multi-level gradation. In the multi-level gradation representation data D2, as shown in FIG. 6, the tones included in the line drawing data D1 are represented as half-tone gradation values. The acquired multi-level gradation representation data D2 is stored in the storage part 11 (with reference to FIG. 3 and FIG. 5).

<Region Separation Part 21>

Referring again to FIG. 3, the region separation part 21 has the function of extracting drawing lines included in the line drawing data D1 read by the scanner 16 to separate a plurality of closed regions surrounded by the drawing lines. Specifically, the region separation part 21 extracts cores (lines of 1-pixel width) by thinning the drawing lines included in the line drawing data D1 (a thinning process) to separate into the plurality of closed regions surrounded by the drawing lines.

FIG. 7 is a view showing an example of thinned data D30 obtained by performing the thinning process on the line drawing data D1 shown in FIG. 4. The region separation part 21 performs the thinning process on the line drawing data D1 to thereby thin the drawing lines included in the line drawing data D1 to the cores having the 1-pixel width. As a result, the region separation part 21 is capable of extracting a multiplicity of closed regions having boundary lines formed by the cores, as shown in FIG. 7. For information about the closed regions surrounded by the cores, the region separation part 21 generates region separation data D3 which will be described below.

Specifically, the region separation part 21 assigns an identification number to each of the closed regions surrounded by the cores (labeling) in the thinned data D30 shown in FIG. 7, and further acquires data about the configuration of a closed region corresponding to each identification number, and the perimeter of the closed region. The term “perimeter” used herein refers to the length of a line or lines (a closed curve) defining the closed region. The term “closed curve” used herein is defined to include a polygonal line in addition to a curve (and hence can be referred to as a “closed loop”).

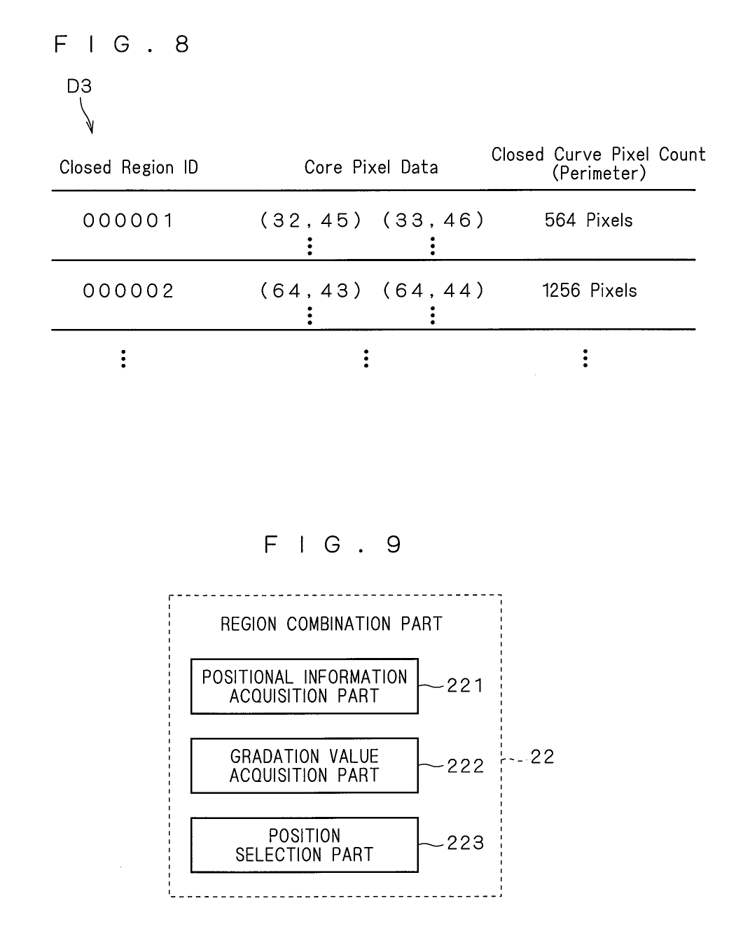

FIG. 8 is a diagram showing an example of a data structure of the region separation data D3. As shown in FIG. 8, “Closed Region ID,” “Core Pixel Data” and “Closed Curve Pixel Count (Perimeter)” are shown in tabular list form in the region separation data D3.

It should be noted that “Core Pixel Data” refers to data about the configuration of the closed region, and indicates positional information (represented in a two-dimensional form of (X, Y)) about pixels constituting the closed curve of the closed region. Also, “Closed Curve Pixel Count (Perimeter)” indicates the perimeter of the closed region or the total number of pixels constituting the closed curve of the closed region. The region separation part 21 stores the generated region separation data D3 in the storage part 11 (with reference to FIG. 3).

<Region Combination Part 22>

The region combination part 22 combines at least two closed regions adjacent to each other on the basis of a predetermined distance together from the multi-level gradation representation data D2, the region separation data D3 and the thinned data D30 in accordance with the degree of coincidence of the gradation values corresponding to the closed regions.

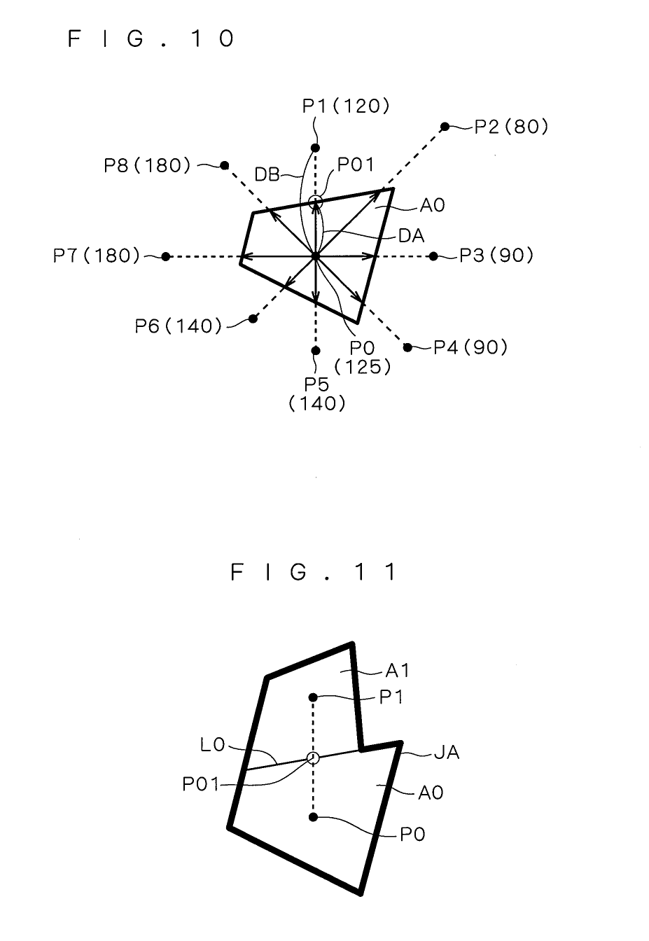

FIG. 9 is a diagram showing functional blocks provided in the region combination part 22. The region combination part 22 includes the following functional blocks: a positional information acquisition part 221, a gradation value acquisition part 222, and a position selection part 223. The region combination part 22 performs a predetermined process to thereby generate region combination data D4.

<Positional Information Acquisition Part 221>

The positional information acquisition part 221 has the function of acquiring barycentric position information about a closed region smaller than a predetermined reference size. Specifically, the positional information acquisition part 221 initially selects a closed region having the number of pixels (perimeter) not greater than a predetermined pixel count (perimeter) by reference to “Closed Curve Pixel Count” in the region separation data D3 to determine a barycentric position included in the closed region.

A method of determining the barycentric position of the closed region includes, for example, generating a rectangle (including a square) circumscribing the closed region to determine the position in which the diagonal lines of the rectangle intersect each other as the barycentric position. An alternative method includes calculating the mean value of the X-direction components and Y-direction components of the positional information about all pixels described in “Core Pixel Data” in the region separation data D3 to acquire the obtained value as the barycentric position information about the closed region.

<Gradation Value Acquisition Part 222>

The gradation value acquisition part 222 has the function of acquiring from the multi-level gradation representation data D2 a gradation value corresponding to the barycentric position acquired by the positional information acquisition part 221 and gradation values corresponding to at least two adjacent positions adjacent to the barycentric position on the basis of a predetermined distance. A specific example will be given below for description.

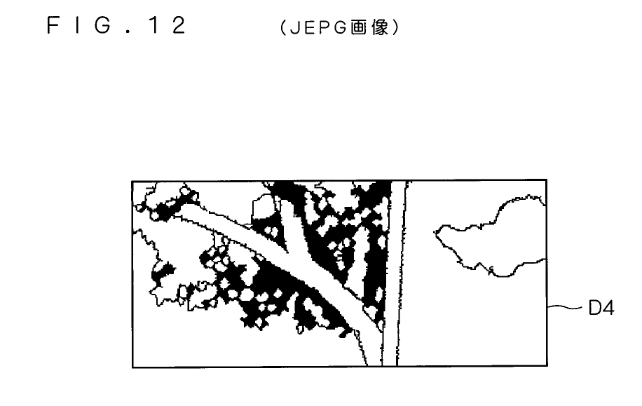

FIGS. 10 and 11 are illustrations of a process performed by the region combination part 22. In the example shown in FIG. 10, a point at the barycentric position (a barycentric point P0) of a closed region A0 having a perimeter not greater than the predetermined perimeter is determined by the positional information acquisition part 221. The gradation value acquisition part 222 defines adjacent points P1 to P8 lying at positions spaced apart from the barycentric point P0 in eight directions and adjacent to the barycentric point P0 on the basis of the predetermined distance. The number of directions is not limited to this, but it is desirable that the number of directions is at least two (for example, four). In this embodiment, the directions are defined so that adjacent ones of the directions make equal angles (45 degrees), as shown in FIG. 10, but are not limited to this.

As shown in FIG. 10, the adjacent point P1 is determined, for example, so that an adjacent point distance DB is twice as long as a boundary point distance DA where the boundary point distance DA is a distance between the barycentric point P0 and an intersection point P01 at which a straight line extending from the barycentric point P0 toward the adjacent point P1 intersects a closed curve L0, and the adjacent point distance DB is a distance from the barycentric point P0 to the adjacent point P1. Also, the gradation value acquisition part 222 provides similar definition for the remaining adjacent points P2 to P8. Thus, the plurality of adjacent points P1 to P8 are defined.

After defining the adjacent points P1 to P8, the gradation value acquisition part 222 acquires gradation values (referred to hereinafter as “corresponding gradation values”) of portions of the multi-level gradation representation data D2 corresponding to the positions of the barycentric point P0 and the adjacent points P1 to P8, respectively. Specifically, the gradation value acquisition part 222 references the multi-level gradation representation data D2, based on the positional information about the barycentric point P0 and the adjacent points P1 to P8, to acquire the gradation values (values indicated in parentheses in FIG. 10) of the corresponding positions, respectively.

<Position Selection Part 223>

The position selection part 223 calculates differences between the corresponding gradation value of the barycentric point P0 acquired by the gradation value acquisition part 222 and the corresponding gradation values of the respective adjacent points P1 to P8 to detect an adjacent point having the corresponding gradation value with the smallest difference (that is, with the highest degree of coincidence with the corresponding gradation value of the barycentric point P0). For example, in the example shown in FIG. 10, the position selection part 223 selects the adjacent point P1 because the difference between the corresponding gradation value (“125”) of the barycentric point P0 and the corresponding gradation value (“120”) of the adjacent point P1 is the smallest. For the purpose of performing the process of combining the closed regions together in the region combination part 22 with higher accuracy, the position selection part 223 may be configured so as to select no adjacent point when the value with the smallest difference is greater than a predetermined threshold value.

As shown in FIG. 11, the region combination part 22 deletes a portion of the boundary line lying between the barycentric point P0 and the adjacent point P1 in the thinned data 30 to combine the closed region A0 including the barycentric point P0 and a closed region A1 including the adjacent point P1 selected by the position selection part 223 together in the form of a single closed region. Specifically, the region combination part 22 deletes the intersection point P01 on the closed curve L0. This generates a combined closed region JA which is a combination of the closed region A0 and the closed region A1. Further, the region combination part 22 acquires data about a closed curve (indicated by thick lines in FIG. 11) defining the combined closed region JA.

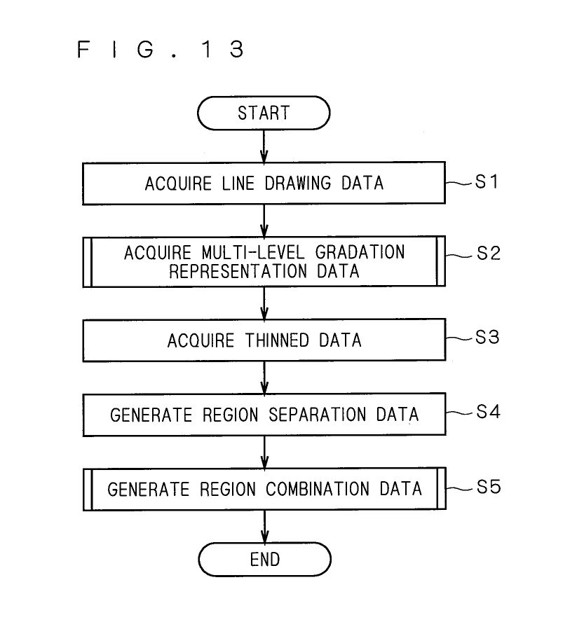

FIG. 12 is a view showing an example of the region combination data D4 acquired from the thinned data D30 shown in FIG. 7. The region combination part 22 repeats the above-mentioned process to thereby generate the region combination data D4 from the thinned data D30. As shown in FIG. 12, a multiplicity of minute regions (portions of “sky,” “leaves of a tree” and “branches of a tree”) included in the thinned data D30 shown in FIG. 7 are combined with each other by the region combination part 22, based on the multi-level gradation representation data D2 shown in FIG. 6.

In this embodiment, the adjacent points P1 to P8 are defined in the positions at a distance that is twice (in general, a predetermined number of times) as long as the boundary point distance DA from the barycentric point P0 (in general, a predetermined point) of the objective closed region A0. In other words, the objective closed region A0 is enlarged to a predetermined number of times, and another closed region overlapping the enlarged closed region A0 is extracted as a closed region that is a candidate for combination. Therefore, the term “adjacent on the basis of a predetermined distance” can be considered to be adjacent to such an extent as to overlap the closed region A0 enlarged to a predetermined number of times after the objective closed region A0 is enlarged to the predetermined number of times.

That is all the description of the configuration and function of the line drawing processing apparatus 1 according to this preferred embodiment.

<1.2. Procedure for Operation of Line Drawing Processing Apparatus>

Next, a procedure for operation of the line drawing processing apparatus 1 is described. The detailed processes of the parts provided in the line drawing processing apparatus 1 already described is not described, as appropriate.

<Acquisition of Line Drawing Data D1>

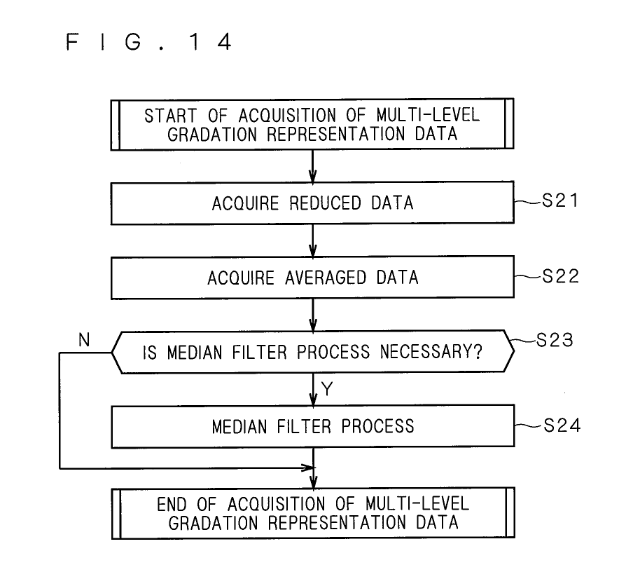

FIG. 13 is a flow diagram for illustrating the procedure for operation of the line drawing processing apparatus 1. First, an operator sets a monochrome line drawing in the scanner 16, and causes the scanner 16 to read the monochrome line drawing, whereby the line drawing processing apparatus 1 acquires the line drawing data D1 (in Step S1). The line drawing processing apparatus 1 stores the acquired line drawing data D1 in the storage part 11.

When the line drawing is drawn by means of another computer and thereby recorded as electronic data, for example, on the recording medium 9, the operator may reads the recording medium 9 by means of the disk reading part 14, and the line drawing processing apparatus 1 may store the read electronic data as the line drawing data D1 in the storage part 11. Also, the line drawing processing apparatus 1 may acquire electronic data about a line drawing through the communication part 15.

<Acquisition of Multi-Level Gradation Representation Data D2>

Next, the line drawing processing apparatus 1 causes the multi-level gradation representation part 20 to generate the multi-level gradation representation data D2 by the representation with a multi-level gradation (in Step S2). A procedure for operation of the multi-level gradation representation part 20 is described below.

FIG. 14 is a flow diagram for illustrating the procedure for operation of the multi-level gradation representation part 20.

First, the multi-level gradation representation part 20 causes the reduction processing part 201 to perform the reduction process on the line drawing data D1 acquired in Step 51, thereby acquiring the reduced data D201 (in Step S21). Next, the multi-level gradation representation part 20 causes the averaging processing part 202 to perform the averaging process on the reduced data D201 acquired in Step S21, thereby acquiring the averaged data D202 (in Step S22).

Further, the multi-level gradation representation part 20 makes a judgment as to whether the median filter process is necessary for the averaged data D202 acquired in Step S22 or not (in Step S23). The operator previously determines whether to perform the median filter process or not for the line drawing processing apparatus 1, whereby the judgment in Step S23 is made. However, the judgment is not limited to this. For example, the multi-level gradation representation part 20 may be configured to perform the median filter process when the amount of noise included in the averaged data D202 is greater than a predetermined reference value as a result of an image analysis performed on the averaged data D202.

When the median filter process is necessary (in the case of YES) in Step S23, the multi-level gradation representation part 20 causes the median filter processing part 203 to perform the median filter process on the averaged data D202, thereby acquiring the multi-level gradation representation data D2 (with reference to FIG. 6), and then storing the acquired multi-level gradation representation data D2 in the storage part 11 (with reference to FIG. 3). On the other hand, when the median filter process is not necessary (in the case of NO) in Step S23, the multi-level gradation representation part 20 stores the averaged data D202 as the multi-level gradation representation data D2 in the storage part 11 (with reference to FIG. 3).

The order of the operations in Step S21 and Step S22 is not limited to that described above, but the operations in Step S21 and Step S22 may be performed in the reverse order. Also, both of the operations in Step S21 and Step S22 need not always be performed. In other words, the multi-level gradation representation part 20 may be configured to execute one of the operations in Step S21 and Step S22.

<Acquisition of Thinned Data D30>

Referring again to FIG. 13, the line drawing processing apparatus 1 causes the region separation part 21 to thin the drawing lines included in the line drawing data D1, thereby acquiring the thinned data D30 (in Step S3, with reference to FIG. 7).

<Acquisition of Region Separation Data D3>

Further, the line drawing processing apparatus 1 causes the region separation part 21 to acquire the region separation data D3 about a plurality of closed regions included in the thinned data D30 (in Step S4, with reference to FIG. 8). The acquired region separation data D3 is stored in the storage part 11.

<Acquisition of Region Combination Data D4>

Next, the line drawing processing apparatus 1 causes the region combination part 22 to acquire the region combination data D4 from the multi-level gradation representation data D2 acquired in Step S2, the thinned data D30 acquired in Step S3 and the region separation data D3 acquired in Step S4 (in Step S5, with reference to FIG. 12). A procedure for operation of the region combination part 22 will be described below.

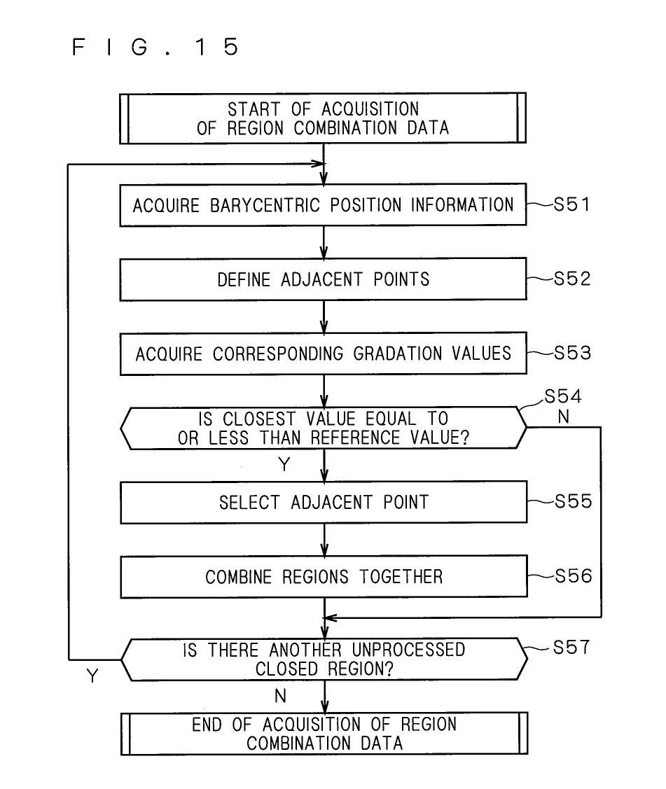

FIG. 15 is a flow diagram for illustrating the procedure for operation of the region combination part 22. First, the region combination part 22 causes the positional information acquisition part 221 to select a closed region smaller than a predetermined reference size from among the plurality of closed regions included in the thinned data D30 by reference to the region separation data D3 acquired in Step S3, thereby acquiring the positional information about a point at the barycentric position (for example, the barycentric point P0) of the selected closed region (in Step S51, with reference to FIGS. 9 and 10).

Next, the region combination part 22 causes the gradation value acquisition part 222 to define a plurality of points (for example, the adjacent points P1 to P8) lying at the adjacent positions adjacent to the barycentric point acquired in Step S51 on the basis of a predetermined distance (in Step S52). Further, the gradation value acquisition part 222 acquires gradation values (corresponding gradation values) corresponding to the barycentric point and the plurality of adjacent points, respectively, from the multi-level gradation representation data D2 acquired in Step S2 (in Step S53).

Next, the region combination part 22 causes the position selection part 223 to calculate differences between the corresponding gradation value of the barycentric point and the corresponding gradation values of the plurality of adjacent points, thereby judging whether the corresponding gradation value closest to the corresponding gradation value of the barycentric point is equal to or less than a predetermined reference value or not (in Step S54).

When it is judged that the corresponding gradation value is equal to or less than the predetermined reference value (in the case of YES) in Step S54, the line drawing processing apparatus 1 causes the position selection part 223 to select the adjacent point (for example, the adjacent point P1 in FIG. 10) having the closest corresponding gradation value (in Step S55). Then, the region combination part 22 deletes a portion of the boundary line between the closed region including the barycentric point and the closed region including the selected adjacent point to thereby combine these closed regions together (in Step S56, with reference to FIG. 11). On the other hand, when the closest corresponding gradation value is greater than the predetermined reference value (in the case of NO) in Step S54, the line drawing processing apparatus 1 causes the procedure to proceed to Step S57.

Next, the region combination part 22 judges whether there is another unprocessed closed region or not by reference to the region separation data D3 (in Step S57). For example, it is effective to judge whether each closed region is processed or not by setting a flag for the processed closed regions in the region separation data D3. When there is an unprocessed closed region (in the case of YES), the region combination part 22 returns to Step S51 to perform the subsequent operations. On the other hand, when the process of all of the closed regions is completed (in the case of NO), the region combination part 22 stores the result of the above combination process as the region combination data D4 into the storage part 11.

That is all the description of the procedure for operation of the line drawing processing apparatus 1.

<1.3. Effect>

The line drawing processing apparatus 1 is capable of rationally combining a plurality of closed regions together, based on the multi-level gradation representation data D2 that reflects the characteristics (patterns applied to the line drawing such as tones) of the line drawing. Therefore, when performing the process of applying color to the line drawing, the line drawing processing apparatus 1 is capable of eliminating the labor of the process of selecting relatively small closed regions (minute regions) one by one to apply color to the relatively small closed regions.

Also, the line drawing processing apparatus 1 is capable of preventing the minute regions from being produced numerously. This reduces the oversight of uncolored regions during the operation of applying color.

Also, in the line drawing processing apparatus 1, the region combination data D4 is generated from the thinned data D30 (the data obtained by performing the thinning process on the drawing lines in the line drawing data DD. Thus, the line drawing processing apparatus 1 is capable of applying color to the region combination data D4 to insert the resultant region combination data D4 into the line drawing data D1. This prevents color application errors such as the painting of color beyond the drawing lines in the line drawing data D1 or the painting of color not reaching the drawing lines.

Also, the line drawing processing apparatus 1 is capable of automating the operation of extracting the closed regions. This makes the operation of extracting the regions and the operation of applying color efficient.

### 2. Second Embodiment

Although only the single adjacent point is defined for each direction from the barycentric point P0 in the first embodiment, the accuracy of the combination process by means of the region combination part 22 is improved by further executing a predetermined process.

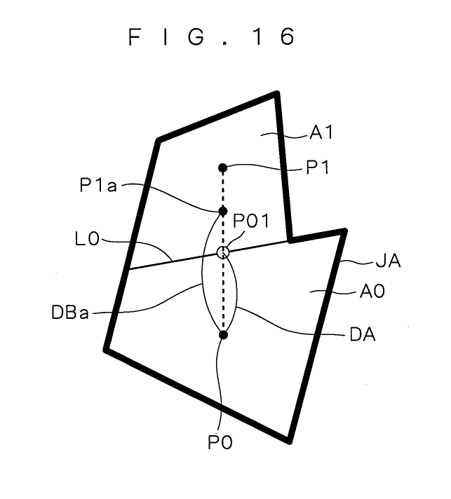

FIG. 16 is an illustration of a process performed by the region combination part 22 according to a second embodiment of the present invention. In FIG. 16, an additional process (a judgment process) is shown as performed for the process of the region combination part 22 shown in FIG. 11.

After the adjacent point P1 is selected by the position selection part 223, the region combination part 22 according to this embodiment further defines a judgment-specific adjacent point P1a positioned at a judgment-specific adjacent point distance DBa from the barycentric point P0 when combining the closed region A0 and another closed region A1 together (in Step S56, with reference to FIG. 15), the judgment-specific adjacent point distance DBa being a predetermined number of times as long as the boundary point distance DA and being shorter than the adjacent point distance DB. In the example shown in FIG. 16, the position of the judgment-specific adjacent point P1a is defined so that the judgment-specific adjacent point distance DBa is 1.5 times as long as the boundary point distance DA. Also, as shown in FIG. 16, the barycentric point P0, the intersection point P01, the adjacent point P1, and the judgment-specific adjacent point P1 a are defined so as to lie on the same straight line and so that the judgment-specific adjacent point P1a is positioned between the intersection point P01 and the adjacent point P1.

Then, the region combination part 22 judges whether the corresponding gradation value of the adjacent point P1 and the corresponding gradation value of the judgment-specific adjacent point P1a are equal to each other or not by calculating the difference therebetween (the judgment process). If these corresponding gradation values are not equal to each other and the difference therebetween exceeding a predetermined reference value is obtained, the region combination part 22 does not perform the combination process. Otherwise, the region combination part 22 performs the combination process of combining the closed region A0 and the closed region A1 together in the form of a single closed region.

As described above, the region combination part 22 performs the judgment process of making a comparison between the corresponding gradation value of the judgment-specific adjacent point P1a and the corresponding adjacent value of the adjacent point P1 to make the judgment. This enables the closed region A0 to be combined with the closed region adjacent thereto with higher reliability. Therefore, the line drawing processing apparatus 1 is capable of performing the combination process with higher accuracy.

### 3. Third Embodiment

In the above-mentioned embodiments, the region combination part 22 is illustrated as performing the combination process upon at least two closed regions adjacent to each other on the basis of the predetermined distance in accordance with the degree of coincidence of the gradation values corresponding to the respective closed regions, based on the corresponding gradation values of the positions of the barycentric point P0 and the adjacent points P1 to P8. The method of combination, however, is not limited to this, but may be accomplished by other methods. In this embodiment, the same components as those described in the above-mentioned embodiment are denoted by the same reference numerals or characters and are not described herein in detail.

<Region Combination Part 22a>

A region combination part 22a according to this embodiment acquires the gradation values corresponding to an objective closed region and an adjacent closed region adjacent to the objective closed region to make a comparison therebetween, thereby performing the process of combining the regions together.

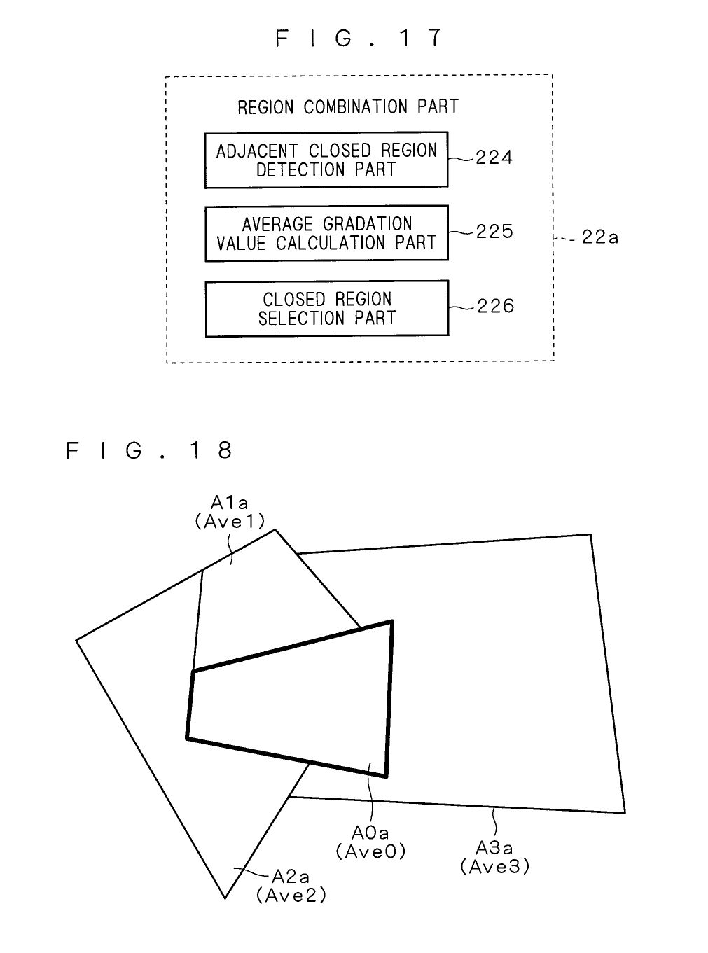

FIG. 17 is a diagram showing functional blocks provided in the region combination part 22a according to a third embodiment. FIG. 18 is an illustration of an example of the combination process performed by the region combination part 22a. As shown in FIG. 17, the region combination part 22a principally includes the following functional blocks: an adjacent closed region detection part 224, an average gradation value calculation part 225, and a closed region selection part 226. These functional blocks is described below.

<Adjacent Closed Region Detection Part 224>

The adjacent closed region detection part 224 has the function of selecting a closed region smaller than a predetermined reference size and then detecting one or more adjacent closed regions adjacent to the selected closed region. Specifically, the adjacent closed region detection part 224 selects a closed region having the number of pixels (perimeter) not greater than a predetermined pixel count (perimeter) by reference to “Closed Curve Pixel Count” in the region separation data D3 in a manner similar to the positional information acquisition part 221 described in the first embodiment.

Then, the adjacent closed region detection part 224 references “Core Pixel Data” in the region separation data D3 to search the pixels constituting the closed curve of a closed region A0a for a pixel that also serves as a pixel constituting the closed curve of another closed region. Thus, an adjacent closed region adjacent to the closed region A0a is detected.

In the example shown in FIG. 18, for example, the closed region A0a is selected as the closed region smaller than the predetermined reference size, and three adjacent closed regions A1a to 3a are detected as the adjacent closed regions for the closed region A0a by the adjacent closed region detection part 224.

<Average Gradation Value Calculation Part 225>

The average gradation value calculation part 225 calculates an average gradation value obtained by the averaging of the corresponding gradation values of the pixels included in the closed region A0a smaller than the predetermined reference size, and one or more adjacent average gradation values obtained by the averaging of the corresponding gradation values of the pixels included in one or more adjacent closed regions.

In the example shown in FIG. 18, for example, the average gradation value calculation part 225 calculates the average gradation value “Ave0” for the closed region A0a and the adjacent average gradation values “Ave1,” “Ave2” and “Ave3” for the adjacent closed regions A1a, A2a and A3a, respectively, by reference to the multi-level gradation representation data D2.

<Closed Region Selection Part 226>

The closed region selection part 226 has the function of detecting an adjacent average gradation value close to (that is, having a high degree of coincidence with) the average gradation value for an objective closed region from among the one or more adjacent average gradation values calculated by the average gradation value calculation part 225 to thereby select an adjacent closed region corresponding to the adjacent average gradation value.

A criterion of judgment on the degree of coincidence of the average gradation values may be a criterion such that “the degree of coincidence is high” when dissimilarity between the average gradation values for two regions to be compared with each other is less than a predetermined judgment threshold value or a relative criterion of judgment such that the closest one of the adjacent average gradation values for a plurality of adjacent closed regions to the average gradation value for the objective closed region has “the high degree of coincidence.” Also, both of the criteria may be used in such a manner that the latter criterion is employed when there are a plurality of adjacent closed regions and the former criterion is employed when there is only a single adjacent closed region.

In the example shown in FIG. 18, for example, the closed region selection part 226 calculates the differences between the average gradation value “Ave0” for the closed region A0a and the adjacent average gradation values “Ave1,” “Ave2” and “Ave3” for the closed regions A1a, A2a and A3a, respectively. Then, the closed region selection part 226 detects the adjacent average gradation value with the smallest difference from “Ave0” to select the adjacent closed region corresponding to the detected adjacent average gradation value (for example, the adjacent closed region A1a when the average gradation value “Ave1” is detected).

The closed region selection part 226 may be configured to select the adjacent average gradation value closest to the average gradation value for the objective closed region, for example, by performing a division, rather than by calculating a difference. Preferably, the closed region selection part 226 is configured not to select the adjacent average gradation value when the adjacent average gradation value is the closest one but is different from the average gradation value for the objective closed region by an amount not less than a predetermined reference value.

Above described are the functional blocks provided in the region combination part 22a.

Using the processing functions of these parts, the region combination part 22a selects an adjacent closed region that is a candidate for combination from among one or more adjacent closed regions adjacent to an objective closed region. Then, the region combination part 22a deletes the boundary line lying between the objective closed region and the selected adjacent closed region to thereby combine these closed regions together in the form of a single closed region.

In the example shown in FIG. 18, for example, when the adjacent closed region A1a is selected as a candidate for combination with the closed region A0a by the closed region selection part 226, the boundary line lying between the closed region A0a and the adjacent closed region A1a is partially or entirely deleted. Thus, the closed region A0a and the adjacent closed region A1a are combined together in the form of a single closed region.

The term “boundary line” used herein refers to a portion where the closed curve surrounding the closed region A0a and the closed curve of the adjacent closed region A1a overlap each other. The term “closed curve” is defined as a concept including not only a curve but also a polygonal line, as mentioned earlier.

Then, the region combination part 22a acquires data about the closed curve surrounding the closed region resulting from the combination (specifically, positional data about the pixels constituting the closed curve). Then, the region combination part 22a performs the process on all of the closed regions, and thereafter stores the result as the region combination data D4 in the storage part 11 (with reference to FIG. 3).

The region combination part 22a repeatedly performs the processes of the above-mentioned functional blocks on the thinned data D30 to thereby combine the closed region smaller than the predetermined reference size with the adjacent closed region adjacent thereto. This allows the suppression of the production of numerous minute closed regions. Further, the process of combining the regions together is performed automatically in accordance with the characteristics (tones, patterns and the like) of the line drawing. Therefore, the operation of cutting out a region for the application of color to the line drawing is efficiently carried out.

Also, according to this embodiment, the region combination part 22a selects a candidate for combination from among the adjacent closed regions adjacent to the objective closed region. This ensures the combination of the closed regions adjacent to each other. Also, this prevents the closed regions adjacent to each other from being combined with each other by mistake when the degree of coincidence of the averaged corresponding gradation values is low.

Further, the comparison is made based on the mean value of the corresponding gradation values of the pixels included in each closed region, rather than the corresponding gradation value of a single pixel, as in the region combination part 22. This eliminates the apprehension of the influence of noise included in the multi-level gradation representation data D2. Also, in the above-mentioned first and second embodiments, the median filter process is performed by the median filter process part 03 (with reference to FIG. 5 and the like). In this embodiment, however, the median filter process is not performed but, for example, the averaged data D202 may be used as the multi-level gradation representation data D2.

### 4. Fourth Embodiment

In the above-mentioned third embodiment, the region combination part 22a is illustrated as making comparisons between the average gradation value Ave0 for the closed region A0a smaller than the predetermined reference size and the adjacent average gradation values Ave1, Ave2 and Ave3 for the adjacent closed region A1a, A2a and A3a to select one adjacent closed region having the average gradation value with the smallest difference, thereby executing the process of combining the closed regions together. The method of the combination process, however, is not limited to this.

<Region Combination Part 22b>

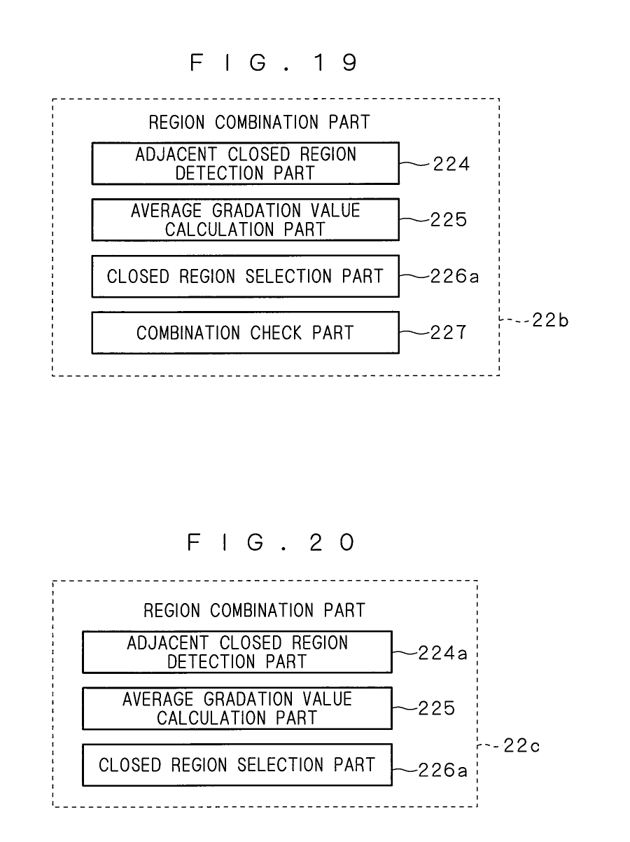

FIG. 19 is a diagram showing functional blocks provided in a region combination part 22b according to a fourth embodiment. The region combination part 22b principally includes the adjacent closed region detection part 224, the average gradation value calculation part 225, a closed region selection part 226a, and a combination check part 227. The adjacent closed region detection part 224 and the average gradation value calculation part 225 are similar to those provided in the region combination part 22a, and are not described in detail.

<Closed Region Selection Part 226a>

The closed region selection part 226a has the function of detecting an average gradation value judged to approximate to (that is, have a high degree of coincidence with) the average gradation value for the objective closed region, based on a predetermined threshold reference (referred to as a “first threshed value”), from among one or more average gradation values calculated by the average gradation value calculation part 225, to select an adjacent closed region corresponding to the detected adjacent average gradation value. More specifically, the closed region selection part 226a will be described with reference to FIG. 18.

In the example shown in FIG. 18, the closed region selection part 226a initially makes comparisons between the average gradation value Ave0 and the adjacent average gradation values Ave1, Ave2 and Ave3. This process is similar to that performed by the closed region selection part 226. Then, the closed region selection part 226a detects an approximate adjacent average gradation value whose amount of dissimilarity (in this case, the difference) from the average gradation value Ave0 is not greater than a predetermined threshold value (or that is judged to have a high degree of coincidence based on a predetermined threshold reference) from among the adjacent average gradation values Ave1, Ave2 and Ave3.

The term “predetermined threshold” used herein may be a constant value that is previously fixed or be determined as appropriate in accordance with the state (style and the like) of the line drawing to be processed. Also, the process is not limited to the comparison in the degree of coincidence by means of the subtraction. For example, the comparison may be made by performing a division.

In this manner, while the closed region selection part 226 detects only the adjacent average gradation value Ave1 closest to the average gradation value Ave0, the closed region selection part 226a detects the remaining adjacent average gradation values Ave2 and Ave3 in a manner similar to the adjacent average gradation value Ave1 when it is judged that the remaining adjacent average gradation values Ave2 and Ave3 have a high degree of coincidence with the average gradation value Ave0. Then, the closed region selection part 226a selects an adjacent closed region (approximate adjacent closed region) corresponding to the detected adjacent average gradation value (approximate adjacent average gradation value) as a candidate region for combination with the closed region A0a.

<Combination Check Part 227>

The combination check part 227 has the function of making a check of the degree of coincidence of the average gradation values for the respective adjacent closed regions when one or more adjacent closed regions selected by the closed region selection part 226a has an adjacent closed region adjacent thereto. Then, when the average gradation values are judged to approximate to each other (that is, to have a high degree of coincidence), based on a predetermined threshold reference (referred to as a “second threshed value”), the region combination part 22b performs the process of combining the one or more adjacent closed regions selected by the closed region selection part 226a and the objective closed region with each other. On the other hand, when the degree of coincidence is low, the combination process is not performed on the closed regions having the low degree of coincidence with each other. In other words, the region combination part 22b performs the combination process in accordance with the result of the check of the combination check part 227. This is described more specifically with reference to FIG. 18.

The description below is based on the assumption that the closed region selection part 226a selects all of the adjacent closed region A1a, A2a and A3a as candidates for combination with the closed region A0a (that is, each of the adjacent average gradation values Ave1, Ave2 and Ave3 is the approximate adjacent average gradation value approximating to Ave0). In this case, the combination check part 227 makes comparisons between the average gradation values for adjacent ones of the selected adjacent closed region A1a, A2a and A3a. Specifically, in the example shown in FIG. 18, comparisons are made between “Ave1” and “Ave2,” between “Ave2” and “Ave3,” and between “Ave3” and “Ave1.”

As a result of the comparison check, when all exhibit the dissimilarity not greater than the predetermined threshold value (that is, a high degree of coincidence), the combination check part 227 judges the regions to be “combinable.” Then, the region combination part 22b performs the process of combining the closed region A0a and the adjacent closed region A1a, A2a and A3a together.

As a result of the comparison check, on the other hand, when “Ave2” and “Ave3” exhibit the dissimilarity greater than the predetermined threshold value (that is, a low degree of coincidence), the combination check part 227 judges the regions to be “uncombinable.” Then, the region combination part 22b combines an adjacent closed region (A2a) corresponding to the closer average gradation value (in this case, “Ave2”) of the two adjacent average gradation values Ave2 and Ave3 to the average gradation value Ave0 and the closed region A0a with each other. On the other hand, the region combination part 22b does not perform the combination process on an adjacent closed region (A3a) corresponding to the adjacent average gradation value (in this case, “Ave3”) having a low degree of coincidence.

As described above, in this embodiment, the closed region selection part 226a selects a plurality of adjacent closed regions serving as candidates for combination at a time. Thus, there is apprehension that an adjacent closed region that an operator is not intended to combine is selected. Specifically, in the example shown in FIG. 18, if “Ave2” and “Ave3” are significantly dissimilar values whereas “Ave0” and “Ave2” approximate to each other and “Ave0” and “Ave3” approximate to each other, there is apprehension that the adjacent closed regions A2a and A3a which are not normally to be combined with each other are formed into a single region because the closed region A0a is adjacent to the adjacent closed regions A2a and A3a.

In this embodiment, however, the comparison is made between the average gradation values Ave2 and Ave3 for the adjacent closed regions A2a and A3a and the judgment is made as to whether to combine the adjacent closed regions A2a and A3a with each other because of the provision of the combination check part 227. This prevents the combination of the regions not intended by the operator to enhance the accuracy of the combination of the closed regions. It should be noted that the above-mentioned first threshold value and second threshold value may be equal to or different from each other.

### 5. Fifth Embodiment

In the above-mentioned embodiments, the adjacent closed region detection part 224 extracts all of the adjacent closed regions adjacent to the objective closed region. However, the preset invention is not limited to this as a matter of course.

<Region Combination Part 22c>

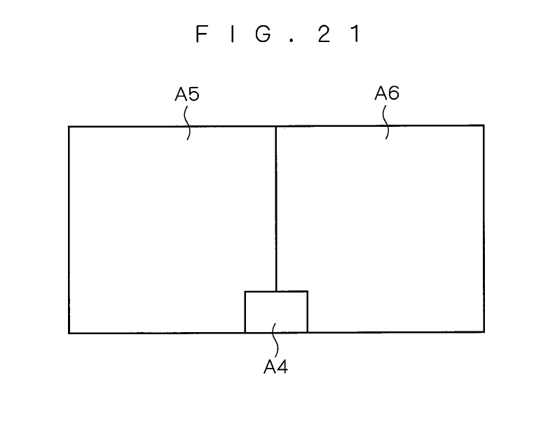

FIG. 20 is a diagram showing functional blocks provided in a region combination part 22c according to a fifth embodiment. The region combination part 22c according to this embodiment principally includes an adjacent closed region detection part 224a, the average gradation value calculation part 225, and the closed region selection part 226a.

<Adjacent Closed Region Detection Part 224a>

The adjacent closed region detection part 224a has the function of initially selecting a closed region smaller than a predetermined reference size (referred to as a first reference size) and then detecting only an adjacent closed region smaller than a predetermined reference size (referred to as a second reference size) from among at least one or more adjacent closed regions adjacent to the selected closed region. Specifically, the adjacent closed region detection part 224a extracts an adjacent closed region by reference to “Core Pixel Data” in the region separation data D3 to detect the adjacent closed region as a candidate for combination only when the adjacent closed region has a perimeter not greater than a predetermined perimeter in a manner similar to the adjacent closed region detection part 224. The first reference and the second reference may be equal to each other or be different reference sizes.

FIG. 21 is a view showing an example of a portion of the thinned data D30. In the example shown in FIG. 21, closed regions A5 and A6 of a relatively large size are adjacent to each other, with a closed region A4 of a small size lying therebetween. In this case, there is a possibility that the region combination part 22b according to the above-mentioned fourth embodiment performs the process of combining the small closed region A4 and the large closed regions A5 and A6 together in the form of a single region.

In general, however, the need to integrate a closed region of a large size with another closed region is originally small, and there arise a large number of detrimental effects resulting from the combination of the closed regions of a large size together (for example, it is impossible to paint in different colors during the process of applying color to the line drawing). Thus, when the large closed regions A5 and A6 are adjacent to each other, with the small closed region A4 lying therebetween, as in the example shown in FIG. 21, it is generally desirable that the large closed regions A5 and A6 be not combined with each other.

In this embodiment, the adjacent closed region detection part 224a selects the adjacent closed region not greater than the predetermined reference size. This prevents the combination of the large adjacent closed regions A5 and A6 shown in FIG. 21 with each other.

### 6. Modifications

Although the embodiments according to the present invention have been described above, the present invention is not limited to the above-mentioned embodiments but various modifications may be made.

For example, the positional information acquisition part 221 acquires the positional information about the barycentric point of the objective closed region A0 in the first and second embodiments, but the present invention is not limited to this. For example, positional information about any predetermined point may be acquired if the predetermined point is included in the closed region A0.

In the gradation value acquisition part 222 according to the first and second embodiments, each adjacent point distance DB is defined so as to be twice as long as the boundary point distance DA. The present invention, however, is not limited to this. It is, however, desirable to configure the gradation value acquisition part 222 to define the adjacent points so that the adjacent point distance DB is greater than the boundary point distance DA for the purpose of acquiring the corresponding gradation value of the adjacent point in a region outside the closed region A0 with reliability.

In the first and second embodiments, the position selection part 223 is illustrated as calculating a difference to thereby determine the degree of coincidence of the corresponding gradation values between the barycentric point P0 and the adjacent points P1 to P8. The present invention, however, is not limited to this. For example, the position selection part 223 may be configured to perform a division to thereby select an adjacent point having the approximate corresponding gradation value.

In the first and second embodiments, the position selection part 223 is illustrated as selecting the adjacent point having the corresponding gradation value closest to the corresponding gradation value of the barycentric point P0 from among the adjacent points P1 to P8. The present invention, however, is not limited to this. For example, the position selection part 223 may be configured to select a plurality of adjacent points at a time when the difference is small (the degree of coincidence is high).

When the position selection part 223 is configured to select a plurality of adjacent points as described above, the accuracy of the combination process may be increased by the provision of a processing mechanism, such as the combination check part 227, for checking the corresponding gradation values of the plurality of adjacent points by comparison therebetween to judge whether to select the adjacent points or not. Alternatively, the region combination part 22 may be configured to perform the process of combining only a closed region not greater than a predetermined size among the closed regions including the adjacent points selected by the position selection part 223 with the objective region.

Also, in the above-mentioned embodiments, the structure of the region separation data D3 is not limited to that illustrated in FIG. 8, but data about the configuration of each closed region may be represented, for example, in the form of a vector. Also, in place of “Closed Curve Pixel Count,” the number of pixels included within the closed curve of the closed region may be described as data indicative of the size (area) of the closed region in the region separation data D3. Even such data indicative of the “area” of the closed region is also usable and effective when the positional information acquisition part 221 and the adjacent closed region detection part 224 select a closed region smaller than the predetermined reference size. Also, the barycentric position information about each closed region and the like may be included in the region separation data D3.

In the above-mentioned embodiments, the processing functions of the line drawing processing apparatus 1 are implemented in the form of software. However, a line drawing processing mechanism may be implemented in the form of hardware by replacing the processing parts with purpose-built circuits that constitute the line drawing processing mechanism.

Of course, the components described in the above-mentioned embodiments and the modifications may be combined together as appropriate in addition to those described above unless the components are inconsistent with each other.

While the invention has been shown and described in detail, the foregoing description is in all aspects illustrative and not restrictive. It is therefore understood that numerous modifications and variations can be devised without departing from the scope of the invention.

1. A line drawing processing apparatus for combining closed regions separated by drawing lines together, comprising:
a line drawing data acquiring part for acquiring digitized line drawing data;
a multi-level gradation representation part for spatially smoothing said line drawing data to thereby acquire multi-level gradation representation data having half-tone pixels;
a region separation part for extracting said drawing lines from said line drawing data to separate regions surrounded by said drawing lines as a plurality of closed regions; and
a region combination part for combining at least two closed regions included among said plurality of closed regions and adjacent to each other on the basis of a predetermined distance together in accordance with the degree of coincidence of gradation values of portions of said multi-level gradation representation data corresponding to the respective closed regions.

2. The line drawing processing apparatus according to claim 1, wherein
said multi-level gradation representation part includes
a reduction part for performing a reduction process on image data.

3. The line drawing processing apparatus according to claim 1, wherein
said multi-level gradation representation part includes
an averaging part for performing an averaging process on the values of respective pixels with a multi-level gradation by using a filter of a predetermined size.

4. The line drawing processing apparatus according to claim 1, wherein
said multi-level gradation representation part includes
a median filter processing part for acquiring the gradation values of pixels near an objective pixel to acquire a median value from said gradation values, thereby defining the median value as the gradation value of said objective pixel.

5. The line drawing processing apparatus according to claim 1, wherein
said region separation part extracts cores of said drawing lines from said line drawing data to separate regions surrounded by said cores as a plurality of closed regions.

6. The line drawing processing apparatus according to claim 5,
wherein said region combination part includes:
a positional information acquisition part for selecting a first closed region smaller than a predetermined reference size from among said plurality of closed regions to acquire positional information about a first position included in the first closed region;
a gradation value acquisition part for acquiring from said multi-level gradation representation data a first gradation value corresponding to said first position and a plurality of gradation values corresponding to at least two adjacent positions adjacent to said first position on the basis of a predetermined distance; and
a position selection part for detecting a gradation value having the highest degree of coincidence with said first gradation value from among said plurality of gradation values to thereby select a second position having the detected gradation value, and
wherein said region combination part deletes a boundary line lying between said first closed region including said first position and a second closed region including said second position to thereby combine said first closed region and said second closed region together in the form of a single closed region.

7. The line drawing processing apparatus according to claim 5, wherein
said region combination part includes:
an adjacent closed region detection part for selecting a third closed region smaller than a predetermined reference size from among said plurality of closed regions to detect one or more adjacent closed regions adjacent to said third closed region;
an average gradation calculation part for calculating a third average gradation value, and one or more adjacent average gradation values, said third average gradation value being obtained by acquiring gradation values corresponding to pixels included in said third closed region from said multi-level gradation representation data and then averaging the gradation values, said one or more adjacent average gradation values being obtained by acquiring gradation values corresponding to pixels included in said one or more adjacent closed regions from said multi-level gradation representation data and then averaging the gradation values; and
a closed region selection part for detecting one or more approximate adjacent average gradation values judged to have a high degree of coincidence with said third average gradation value on the basis of a predetermined criterion of judgment from among said one or more adjacent average gradation values to thereby select one or more approximate adjacent closed regions corresponding to said one or more approximate adjacent average gradation values from among said one or more adjacent closed regions.

8. The line drawing processing apparatus according to claim 7,
wherein said region combination part includes
a comparison check part for making a comparison between said approximate adjacent average gradation values for approximate adjacent closed regions included among said one or more approximate adjacent closed regions and adjacent to each other, and
wherein said region combination part combines said third closed region and said one or more approximate adjacent closed regions together in accordance with a result of the comparison check of said comparison check part.

9. A storage medium storing a computer-readable program executable by a computer, wherein execution of said program by said computer causes said computer to function as a line drawing processing apparatus comprising:
a line drawing data acquiring part for acquiring digitized line drawing data;
a multi-level gradation representation part for spatially smoothing said line drawing data to thereby acquire multi-level gradation representation data having half-tone pixels;
a region separation part for extracting said drawing lines from said line drawing data to separate regions surrounded by said drawing lines as a plurality of closed regions; and
a region combination part for combining at least two closed regions included among said plurality of closed regions and adjacent to each other on the basis of a predetermined distance together in accordance with the degree of coincidence of gradation values of portions of said multi-level gradation representation data corresponding to the respective closed regions.

10. A method of processing a line drawing, said method combining closed regions separated by drawing lines together, said method comprising the steps of:
(a) acquiring digitized line drawing data;
(b) spatially smoothing said line drawing data to thereby acquire multi-level gradation representation data having half-tone pixels;
(c) extracting drawing lines from said line drawing data to separate regions surrounded by said drawing lines as a plurality of closed regions; and
(d) combining at least two closed regions included among said plurality of closed regions and adjacent to each other on the basis of a predetermined distance together in accordance with the degree of coincidence of gradation values of portions of said multi-level gradation representation data corresponding to the respective closed regions.
